(19) United States
(12) Patent Application Publication
(10) Pub. No.: US 2020/0182748 A1
(43) Pub. Date: Jun. 11, 2020

(54) Test Strip for Seals

(71) Applicant: Planet GDZ AG, Tagelswangen (CH)

(72) Inventor: Andreas Dintheer, Illnau (CH)

(21) Appl. No.: 16/631,582

(22) PCT Filed: Jun. 29, 2018
(86) PCT No.: PCT/EP2018/067672

§ 371 Date: Jan. 16, 2020

(30) Foreign Application Priority Data
Jul. 17, 2017 (EP) 17181638.2

(51) Int. Cl. G01M 99/00; G01L 1/22; G01L 5/00

(52) U.S. Cl. CPC G01M 99/00; E06B 7/18; G01L 5/0033; G01L 1/2287

(57) ABSTRACT

A test strip for checking a contact pressure of a seal has a checking element. By means of the checking element, the test strip indicates whether the contact pressure is less than or greater than specified contact pressure. The test strip indicates whether the contact pressure lies within a specified range. There preferably two weakening lines for this purpose, which tear at different contact pressures when tension is applied while the test strip is clamped.

### TECHNICAL SCOPE

The present invention relates to a test strip for seals, in particular for drop-down seals and preferably for drop-down seals which rest in a spring-loaded manner on a surface to be sealed, and to a test set having such test strips and to a method for checking a contact pressure of a seal.

### PRIOR ART

Seals, in particular drop-down seals, are used for doors or for windows in order to seal a gap between the leaf of a door or window and the door frame or floor against draft, noise and light transmission. A seal that is mechanically lowerable automatically has been used successfully for years, such as is disclosed, for example, in EP 0 338 974.

The actuation of the drop-down seal is effected automatically on one or two sides when the door or window is opened or closed, by a spring-loaded release bolt, which protrudes from the leaf, being displaced, preferably pushed in, during closing. As a result, a sealing strip is lowered away from the leaf by means of a lowering mechanism. When the door leaf is opened, the release bolt is released again, the springs are able to relax and the lowering mechanism is raised up toward the leaf again thanks to the resetting force of the springs. Examples of corresponding lowering mechanisms can be found in DE 19 516 530, EP 0 509 961, DE 3 526 720, DE 3 418 438 and in DE 3 427 938.

The lift of the sealing strip, the spring pressure and the condition of the surface to be sealed have a considerable influence on the quality of the sealing action. In particular in the case of outside doors, it is very important for protection against weather influences, in particular as protection against driving rain, that the sealing strip is pressed sufficiently firmly onto the surface to be sealed. The contact pressure consequently has to be sufficiently high. It can be optimized, for example, by adjusting the lift, whether it be for assembly of the seal or for regular inspections.

The adjusting of the lift can be achieved in different ways depending on the type of lowering mechanism. If, for example, there is an actuating button which protrudes from the front of the housing and acts on a spring-loaded slide, the lift can be modified, for example, as a result of adjusting the distance the actuating button protrudes from the housing. As an alternative to this or in addition to it, the lift can also be determined usually by assembling the seal at a corresponding distance from the surface to be sealed.

Drop-down seals that rest too firmly, i.e. the contact pressures are too high, lead to a restricted method of operation. In addition, the service life of the elastomer seal profile is severely reduced as the sealing strip rests on the floor even when the door is not completely closed and the seal profile consequently slips over the floor and becomes worn too quickly.

### REPRESENTATION OF THE INVENTION

It is, consequently, an object of the invention to create a test possibility for seals, in particular for drop-down seals, which allows the seal to be adjusted optimally to the local conditions.

Said object is achieved by a test strip with the features of claim 1, a test set with the features of claim 14 and a method with the features of claim 15 or 16.

The test strip according to the invention for checking a contact pressure of a seal comprises a control element, wherein the test strip indicates by means of said control element whether the contact pressure is lower or higher than a specified contact pressure.

In preferred embodiments, said indication is effected as a result of modifying the control element, e.g. by it changing the color or shape or by it being torn, broken, broken up or destroyed in another manner.

In a further embodiment, the test strip comprises a strain sensor which detects the tensile force when the test strip is pulled out so that conclusions are able to be drawn on the contact pressure acting on the test strip. The strain sensor is preferably a strain gauge (DMS) which modifies its electrical resistance when a tensile force acts on the test strip.

Depending on the embodiment, the strain gauge is integrated in the test strip or forms the same itself. The measured value of the strain gauge can be indicated optically on the test strip, for example by changing color or a different light indication. It can also be retrieved, however, by suitable electronic means, for example it can be displayed by means of an app on a smart phone, tablet or another intelligent electronic device.

The displaying means, e.g. the smart phone, indicates in a first embodiment whether a contact pressure is at least minimum, in a second embodiment whether it exceeds a predefined maximum contact pressure and in a third embodiment whether it lies between a predefined minimum and a predefined maximum contact pressure. The associated app (application), which retrieves the change in resistance in the DMS and, based on said obtained value, sets the current contact pressure in relation to a minimum and/or a maximum predefined contact pressure, is also claimed here.

Said test strip serves for checking the contact pressure and consequently makes it possible to adjust the contact pressure in an optimum manner, for example by the lift of the drop-down seal being correspondingly modified or a window or a door being re-set with a sliding seal or another type of seal, e.g. by it being mounted higher or lower.

In simple embodiments two different test strips are present, from which a first test strip indicates a minimum specified contact pressure and a second test strip indicates a maximum specified contact pressure.

In preferred embodiments, two or more control elements are arranged on or in the same test strip, each individual one of which showing a reaction, in particular a change, in the case of a different contact pressure.

By using different test strips and/or multiple different control elements on the same test strip, it can be ascertained in a simple manner whether the seal presses too firmly and whether it presses too weakly on the surface to be sealed. I.e. it can be ascertained whether the contact pressure lies within a specified ideal range.

As the contact pressure depends on the individual conditions on site and consequently can vary strongly, said simple control, which can be carried out on site, is advantageous.

Testing the contact pressure of window seals by clamping a sheet of paper between the seal rubber and the window frame is certainly known. If the paper can no longer be pulled out when the window is closed, the seal is deemed to be satisfactory. As, however, when the tensile force is applied to a sufficiently large extent and in a sufficiently slow manner, the paper can practically always be pulled out undamaged, this is not a sufficiently clear indicator. In addition, it is not possible to ascertain in this way whether the contact pressure lies within a specified range.

The control element according to the invention can be at least one zone on the test strip which can be modified, in particular colored, under pressure. The test strip can also emit an optical, acoustic or electronic or another suitable signal in dependence on the contact pressure acting thereon. The control element, however, is preferably a tear line of the test strip which tears at a specified contact pressure when tensile force is applied with the test strip in the clamped state. This is a simple and cost-efficient realization of the test strip and the contact pressure can be checked by anyone without a large amount of prior knowledge and without technical devices.

The control element is preferably a tear line. Said tear line is formed, for example, by thinning the material or using a material that is different to the rest of test strip. It is preferably realized, however, as a perforation. Perforations are a cost-efficient design. In addition, such perforations which only tear at predefined forces are well known in the prior art, for example from the packaging industry.

Depending on the type of perforation, the test strip tears at a certain contact pressure when it is pulled by hand. If, then, two test strips are realized with different tear lines or perforation or if one test strip is realized with two different tear lines or perforations, a minimum and a maximum specified contact pressure can thus be ascertained. To this end, a first tear line preferably tears when the tensile force acting on the test strip is lower than that acting on a second tear line. If the tear lines are perforations, the perforation of the first tear line is thus consequently preferably realized in a stronger manner than that of the second tear line.

In place of a second tear line or perforation, the material of the entire test strip can also be realized such that it tears anyway at a specified maximum contact pressure.

The first tear line and the second tear line are preferably arranged spaced apart from one another so that their tensile strength is able to be utilized successively. The distance is preferably at least as large as the width of the seal, in particular of the drop-down seal. The distance is preferably larger than the thickness of the leaf of the door or window.

The first tear line and the second tear line are preferably arranged one behind the other in the longitudinal direction of the test strip. This enables the simple realization of a gripping region in order to be able to hold the test strip in a simple manner by hand. In addition, a minimum surface is required as a result for the test strip.

The first tear line and the second tear line are preferably arranged parallel to one another. This simplifies optimum adaptation of the tear lines to the desired tensile strength.

The first tear line and the second tear line preferably extend perpendicularly to the longitudinal direction of the strip. This also enables a minimized realization of the test strip.

The two tear lines preferably divide the strip into three portions, wherein a first portion lies between a free end of the strip and the first tear line and forms a first test portion, wherein a second portion lies between the first and the second tear lines and forms a second test portion and wherein a third portion lies between the second tear line and the opposite second free end of the strip and forms a gripping portion so that the test strip can be held between two fingers of a human hand. The two test portions, in this case, are preferably at least as long as the width of the seal, in particular of the drop-down seal.

The test strip preferably consists of paper. However, it can also consist of another suitable material, for example plastics material.

The test strip preferably comprises at least one marking to make using the test strip easier. Said marking can indicate the direction, for example, in which manual pulling is to take place.

Multiple test strips are preferably combined to form a test set which is realized as a block, wherein the block preferably comprises a bond from which the test strips are tearable. Said block can be carried easily by the workman, is light and hardly requires any space.

In the method according to the invention for checking a contact pressure of a drop-down seal with a test strip, in a first step the first test portion of the test strip is pushed into a gap between the drop-down seal and a surface to be sealed. A sealing strip of the drop-down seal is lowered onto said first test portion. The gripping portion is then pulled by hand in order to check whether the clamped test strip tears as a result at the first tear line. The drop-down seal is then raised again. In a second step the second test portion of the test strip is pushed into a gap between the drop-down seal and a surface to be sealed. The sealing strip of the drop-down seal is lowered onto said second test portion and is pulled by hand again at the gripping portion in order to check whether the test strip tears as a result at the second tear line. If only the first tear line tears but not the second one, the contact pressure lies within the desired range. If none of the lines tear, the contact pressure is thus too low. If both lines tear, the contact pressure is thus too high.

The same method can be carried out with other seals in the case of windows or doors by the window or the doors being closed or re-opened in place of the lowering and raising of the seal. Said method is also claimed as an invention.

In an embodiment, the minimum and maximum contact pressure is defined by absolute values and said values are taken into account when producing the test strip. In other embodiments, it is established empirically, for example by an expert in the seal sector, in particular in the sector of drop-down seals, carrying out tests on an existing seal and, based on his empirical values, establishing when the contact pressure of a seal is too high and when it is too low. In the case of a drop-down seal, an even more acceptable minimum contact pressure is present when a seal profile, which rests on the floor in a practically undeformed manner once the sealing strip has been lowered, still holds a paper strip in such a manner that a noticeable effort is necessary in order to pull the clamped paper strip out again. An even more acceptable maximum contact pressure is present when the seal profile in the lowered state is certainly deformed but said deformation also satisfies visual requirements for aesthetics and the sealing strip does not slip too strongly over the floor when the door is closed and impede the closing of the door. The criteria with reference to “firm”, “weak”, “noticeable effort” etc. are established by the expert as a result of his experience. Even if this can be absolutely subjectively colored criteria, such an empirically selected test strip does help the layman to make decisions, based on the expertise of third parties, as to whether the seals in his home meet a standard or have to be re-adjusted.

Further embodiments are specified in the dependent claims.

### BRIEF DESCRIPTION OF THE DRAWINGS

Preferred embodiments of the invention are described below by way of the drawings which serve purely for explanation and are not to be seen as limiting. The drawings are as follows:

FIG. 1 shows a perspective representation of part of a lowered drop-down seal in a door frame with a test strip according to the invention when checking a downwardly acting contact pressure;

FIG. 2 shows a perspective representation of the test strip according to FIG. 1 before use;

FIG. 3 shows the representation according to FIG. 1 with the test strip according to the invention when checking a front-acting contact pressure;

FIG. 4 shows the representation according to FIG. 1 when checking a minimum specified contact pressure;

FIG. 5 shows the test strip according to FIG. 4 after detection of a contact pressure higher than the minimum specified contact pressure;

FIG. 6 shows the representation according to FIG. 3 when checking the minimum specified contact pressure;

FIG. 7 shows the representation according to FIG. 1 when checking a maximum specified contact pressure;

FIG. 8 shows the test strip according to FIG. 7 after detection of a contact pressure higher than the maximum specified contact pressure;

FIG. 9 shows the representation according to FIG. 3 when checking the maximum specified contact pressure;

FIG. 10 shows a view from above of the test strip according to FIG. 2;

FIG. 11 shows a view from above of the test strip according to FIG. 5;

FIG. 12 shows a view from above of the test strip according to FIG. 8 and

FIG. 13 shows a test set with the test strip according to the invention according to FIG. 2.

### DESCRIPTION OF PREFERRED EMBODIMENTS

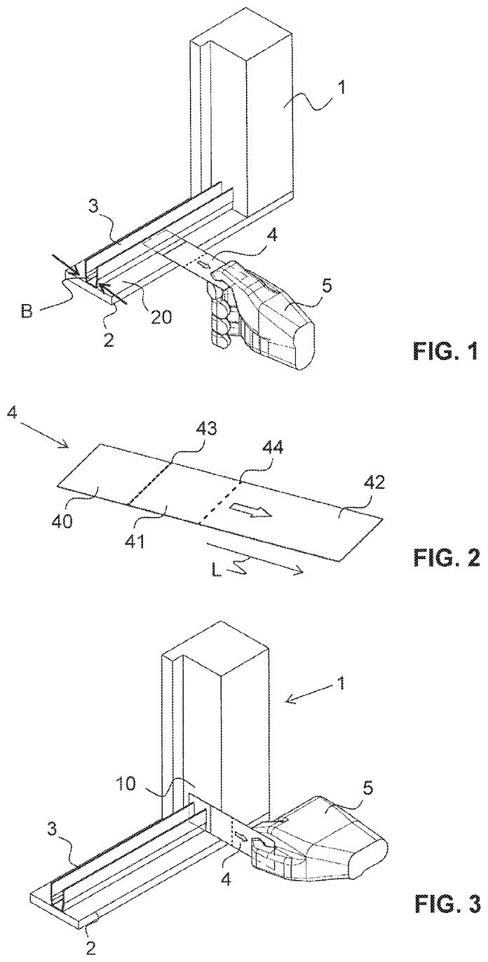

FIG. 1 shows a schematic representation of a seal situation in the region of the door. The same applies to a region of a window so that “doors” are also to be understood below as a generic term for windows. In addition, the test strip according to the invention is described when used for a drop-down seal. The test strip can also be used for other types of seals, such as, for example, sliding seals or fixed seals, as are usually mounted circumferentially in the case of doors and windows.

The reference symbol 1 designates a partially shown door frame. The reference symbol 2 refers to a floor or a threshold which is aligned with the floor. The surface to be sealed by means of the drop-down seal is provided with the reference symbol 20. The leaf of the door is not shown. It is situated logically between the floor 2 and the door frame 1. Neither is the drop-down seal, which is fastened to the leaf of the door, fully shown. Simply shown is a portion of a seal profile 3 which is lowerable and raisable again as part of a sealing strip. The sealing strip is preferably lowerable automatically, in particular mechanically, when the leaf of the door is closed and is also automatically raisable again when the leaf of the door is opened.

All known drop-down seals, in particular the ones described in the introduction, can be used as drop-down seals. The seal profile or the sealing strip is preferably pressed actively downward by means of a contact pressure when the door is closed and it is consequently in the lowered state. Depending on the embodiment, an active or passive contact pressure can also be present at the front. Actively, in this context, means, for example, that a force acts on a lowering mechanism which presses the sealing strip downward. Said force is exerted, in the case of the drop-down seals described in the introduction, by the release bolt which is disposed at the door frame and presses the sealing strip downward, on the one hand, and, depending on the embodiment of the lowering mechanism, on the other hand also pushes the sealing strip in a horizontal direction and consequently exerts a force in the longitudinal direction of the seal onto the front-side region of the door frame 1. Other drop-down seals are also known which press the sealing strip in both horizontal directions against both sides of the door frame. The test strip can also be used optimally for said type of drop-down seals.

A test strip 4 according to the invention can now be used for checking the contact pressure of the sealing strip or of the seal profile 3 on the lower surface 20 to be sealed. The test strip 4, in this case, is clamped between the lowered seal profile 3 and the surface 20 to be sealed, as is explained later in the text. It is then pulled by hand 5 and checked to see whether the test strip 4 tears. FIG. 1 shows the checking of the contact pressure which acts in a downward manner. FIG. 3 shows the checking of the contact pressure which acts at the front or at the side. In the last case, the test strip 4 is clamped between the door frame 1 and the lowered sealing strip 3.

The test strip 4 is preferably produced from paper and/or plastics material, in particular from a single or multiple-layer foil.

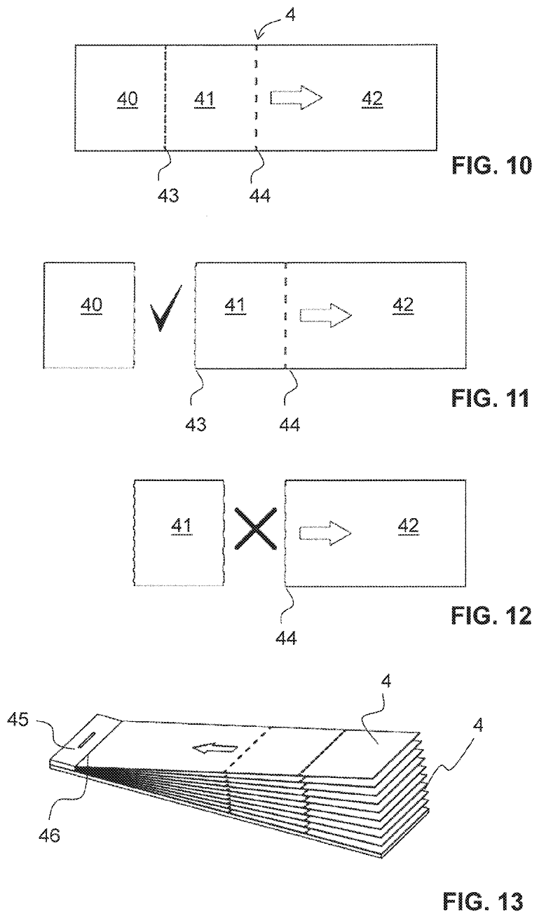

FIGS. 2 and 10 show the test strip 4 according to the invention before use. It comprises three regions 40, 41, 42 which are separated from one another by two tear lines 43, 44. The two tear lines 43, 44 preferably extend spaced apart from one another and parallel to one another. They extend preferably perpendicularly to the longitudinal direction of the test strip 4.

The tear lines 43, 44 can be, for example, thinnings or another weakening, at which the test strip tears in a preferred manner. The tear lines 43, 44 are preferably perforations.

The two tear lines 43, 44 are realized with different strengths so that they tear at different tensile forces. A first tear line 43 preferably tears more quickly, that is to say at a lower contact pressure than a second tear line 44. If the tear lines 43, 44 are perforations, the perforation of the first tear line 43 is thus preferably realized in a stronger manner than the perforation of the second tear line 44. For example, it comprises larger empty spaces and smaller connecting webs. This can be seen well, for example, in FIG. 10.

A first region of the test strip 4, which extends from a free end of the strip to the first tear line 43, forms a first test portion 40. A second region, which forms a second test portion 41, is situated between the first and the second tear lines 43, 44. The two test portions 40, 41 comprise a length L₁, L₂ which corresponds to at least the width of the drop-down seal B.

A third region is formed by the zone between the second tear line 44 and the second free end. Said third region is a gripping portion 42. It is of a size that can be held well with two fingers of a human hand. The test strip 4 can easily be pulled in the clamped state. This can be seen well in FIG. 1. The weaker tear line 43, that is to say the tear line which tears more quickly, is preferably situated further away from the gripping portion 42 than the stronger tear line 44, that is to say the tear line which tears less quickly.

At least one marking and/or at least one instruction for using the test strip 4 are preferably printed on the test strip 4. Thus, for example, a printed arrow can indicate the pulling direction, as is shown in FIGS. 1 and 10. The two test portions 40, 41 can also be numbered so that the user can recognize which test portion 40, 41 is to be clamped first of all. Markings, labels or symbols, which show whether tearing the test strip 4 at this point is to be understood as a positive or a negative result, can be additionally specified in the regions of the tear lines 43, 44. Said information is not shown in the figures.

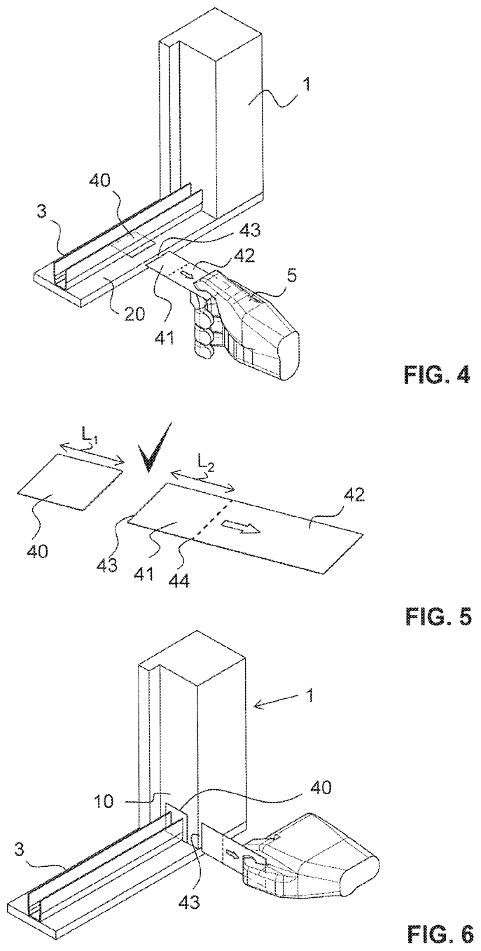

FIGS. 4 to 6 and 11 show how the test strip 4 can be used to test whether the lowered drop-down seal comprises a specified minimum contact pressure on the floor-side and/or the end-side.

The test strip 4 is placed for this purpose with its first test portion 40 onto the surface 20 to be sealed or is held at said surface 10 to be sealed. The door is then closed so that the drop-down seal is actuated and the sealing strip is lowered with the seal profile 3. The first test portion 40 is clamped between the sealing profile 3 and the surface 20, 10. If it is then pulled by hand and the contact pressure corresponds to at least the above-mentioned minimum pressure, the test strip tears at the first tear line 43. This can be seen in FIGS. 5 and 11. The first tear line 43, in particular the first perforation, is realized in a corresponding manner on the part of the manufacturer. This can be achieved using known means.

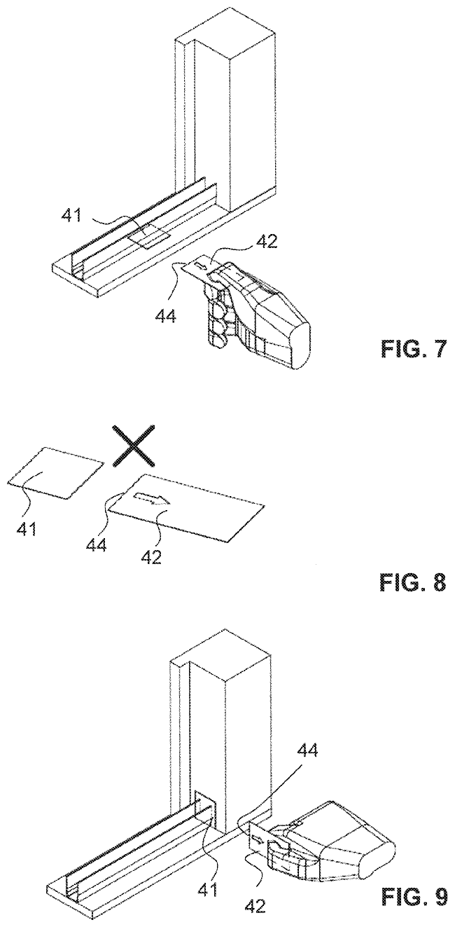

FIGS. 7 to 9 and 12 show how to test whether or not the contact pressure is too high. The drop-down seal is raised once again for this purpose. The test strip 4 is placed onto the lower surface 20 or against the front surface 10 without the already torn first test portion 40. The drop-down seal is lowered once again so that the second test portion 41 is now clamped. It is pulled by hand once again. If said second tear line 44 also tears, the contact pressure is too high. If, in contrast, it does not tear, the contact pressure thus lies within the desired optimum range.

As an alternative to this, it is naturally also possible to use a new test strip 4 which still comprises the first test portion 40. In this case, however, the second test portion 41 is nevertheless to be clamped.

A reverse arrangement of the test portions 40, 41 or of the tear lines 43, 44 is, however, also possible. I.e. the first tear line can tear at a higher contact pressure than the second tear line. In this case, the second test portion 41 is clamped first of all, this time, however, for checking the minimum contact pressure. The second test portion 41 then becomes the gripping portion and, together with the first test portion 40 which is still to be clamped, serves for checking the specified maximum contact pressure.

The test strips 4 can be packaged individually or can be present in a common packaging. Multiple test strips 4 are preferably combined to form a common block which makes it possible for the individual test strips to be torn off or detached. This is shown in FIG. 13. The block preferably comprises a connection 45 to a short side. The connection 45 is preferably an adhesive bond and/or a stitched connection. A perforation 46 is preferably present in order to make the removal of the individual test strips 4 easier.

The test strip according to the invention makes it possible to adjust a drop-down seal of a window or a door with a seal in an optimum manner.

### LIST OF REFERENCES

| | |
|---|---|
| 1 | Door frame |
| 10 | End surface to be sealed |
| 2 | Floor |
| 20 | Lower surface to be sealed |
| 3 | Sealing profile |
| 4 | Test strip |
| 40 | First test portion |
| 41 | Second test portion |
| 42 | Gripping portion |
| 43 | First tear line |
| 44 | Second tear line |
| 45 | Bond |
| 46 | Perforation |
| 5 | Hand |
| L | Longitudinal direction of the strip |
| L₁ | Length of the first test portion |
| L₂ | Length of the second test portion |
| B | Width of the drop-down seal |

1. A test strip for checking a contact pressure of a seal, the test strip comprising:
a control element,
a) wherein the test strip indicates via the control element whether the contact pressure is lower than a specified contact pressure, or
b) wherein the test strip indicates via the control element whether the contact pressure is higher than the specified contact pressure.

2. The test strip as claimed in claim 1, wherein the control element indicates both whether the contact pressure is lower than the specified contact pressure and whether the contact pressure is higher than the specified contact pressure.

3. The test strip as claimed in claim 1, wherein the control element is a mechanical, an optical, an acoustic or an electronic element.

4. The test strip as claimed in claim 1, wherein the control element is a strain gauge.

5. The test strip as claimed in claim 1, wherein the control element is a tear line which tears at the specified contact pressure.

6. The test strip as claimed in claim 5, wherein the tear line is a perforation.

7. The test strip as claimed in claim 1, the test strip indicating whether the contact pressure lies within a specified range.

8. The test strip as claimed in claim 7, wherein the control element is a first control element for detecting a minimum specified contact pressure, and wherein the test strip comprises a second control element for detecting a maximum specified contact pressure.

9. The test strip as claimed in claim 8, wherein the first control element is a first tear line and the second control element is a second tear line, and wherein the first tear line tears when the tensile force acting on the test strip is different to the tensile force acting on the second tear line.

10. The test strip as claimed in claim 9, wherein the first tear line tears when the tensile force acting on the test strip is lower than the tensile force acting on the second tear line.

11. The test strip as claimed in claim 9, wherein the first tear line and the second tear line are arranged one behind the other in the longitudinal direction of the test strip.

12. The test strip as claimed in claim 9, wherein the first tear line and the second tear line are perforations, and wherein the perforation of the first tear line is more pronounced than the perforation of the second tear line so that the first tear line tears more quickly than the second tear line.

13. The test strip as claimed in claim 9, wherein the two tear lines divide the test strip into three portions, wherein a first portion lies between a first free end of the test strip and the first tear line and forms a first test portion, wherein a second portion lies between the first tear line and the second tear line and forms a second test portion, and wherein a third portion lies between the second tear line and a second free end of the strip and forms a gripping portion so that the test strip is configured to be held between two fingers of a human hand.

14. The test strip as claimed in claim 1, wherein the test strip comprises at least one marking to make using the test strip easier.

15. A test set having multiple test strips according to claim 1, wherein the multiple test strips are combined to form a block, and wherein the block comprises a bond from which the test strips are tearable.

16. A method for checking a contact pressure of a drop-down seal with a test strip according to claim 12, the method comprising:
pushing the first test portion of the test strip into a gap between the drop-down seal and a surface to be sealed;
lowering a sealing strip of the drop-down seal onto said first test portion and pulling by hand at the gripping portion in order to check whether the test strip tears as a result at the first tear line;
raising the drop-down seal;
pushing the second test portion of the test strip into the gap between the drop-down seal and the surface to be sealed; and
lowering the sealing strip of the drop-down seal onto said second test portion and pulling by hand at the gripping portion in order to check whether the test strip tears as a result at the second tear line.

17. A method for checking a contact pressure of a drop-down seal with a test strip according to claim 12, the method comprising:
pushing the second test portion of the test strip into a gap between the drop-down seal and a surface to be sealed;
lowering a sealing strip of the drop-down seal onto said second test portion and pulling by hand at the gripping portion in order to check whether the test strip tears as a result at the second tear line;
raising the drop-down seal;
in an event of the second tear line being torn, pushing the first test portion of the test strip into the gap between the drop-down seal and the surface to be sealed; and
lowering the sealing strip of the drop-down seal onto said first test portion and pulling by hand at the second test portion in order to check whether the test strip tears as a result at the first tear line.
